(19) United States
(12) Patent Application Publication
(10) Pub. No.: US 2026/0040062 A1
(43) Pub. Date: Feb. 5, 2026

(54) MODULATION SYMBOL ENCRYPTION METHOD, USER EQUIPMENT AND NETWORK NODE

(71) Applicant: SAMSUNG ELECTRONICS CO., LTD., Suwon-si (KR)

(72) Inventors: Nan JIANG, Beijing (CN); Yu XIAO, Beijing (CN); Di SU, Beijing (CN); Chen QIAN, Beijing (CN)

(21) Appl. No.: 19/290,179

(22) Filed: Aug. 4, 2025

(30) Foreign Application Priority Data
Aug. 2, 2024 (CN) 202411061038.X

(51) Int. Cl. H04W 12/037

(52) U.S. Cl. CPC H04W 12/037

(57) ABSTRACT

The disclosure relates to a 5G or 6G communication system for supporting a higher data transmission rate. Embodiments of the present disclosure provide a method of modulation symbol encryption in a communication system, comprising: obtaining a first sequence for encrypting a complex-valued modulation symbol sequence based on a second sequence, wherein the second sequence is associated with a root key sequence or a secondary key sequence, or with a radio frequency characteristic of a user equipment; encrypting the complex-valued modulation symbol sequence based on the first sequence to obtain an encrypted complex-valued modulation symbol sequence; obtaining a baseband signal based on the encrypted complex-valued modulation symbol sequence.

### CROSS-REFERENCE TO RELATED APPLICATION

This application is based on and claims priority under 35 U.S.C. § 119 to Chinese Patent Application No. 202411061038.X, filed on Aug. 2, 2024, in the Chinese Intellectual Property Office, the disclosure of which is incorporated by reference herein in its entirety.

### BACKGROUND

### 1. Field

The present application relates to the field of communications and, more particularly, to modulation symbol encryption method, user equipment and network node.

### 2. Description of Related Art

In order to meet the increasing demand for wireless data communication services since the deployment of 4^{th} generation (4G) communication systems, efforts have been made to develop improved 5G or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The present application relates to the field of communications and, more particularly, to modulation symbol encryption method, user equipment and network node.

The technical objects to be achieved by various embodiments of the disclosure are not limited to the technical objects mentioned above, and other technical objects not mentioned may be considered by those skilled in the art from various embodiments of the disclosure to be described below.

According to an aspect of the present disclosure, there is provided a method of modulation symbol encryption in a communication system, comprising: obtaining a first sequence for encrypting a complex-valued modulation symbol sequence based on a second sequence, wherein the second sequence is associated with a root key sequence or a secondary key sequence, or with a radio frequency characteristic of a user equipment; encrypting the complex-valued modulation symbol sequence based on the first sequence to obtain an encrypted complex-valued modulation symbol sequence; obtaining a baseband signal based on the encrypted complex-valued modulation symbol sequence.

According to the method of modulation symbol encryption in the communication system provided by the present disclosure, wherein the obtaining the first sequence for encrypting the complex-valued modulation symbol sequence based on the second sequence comprises at least one of: in case the second sequence includes at least one real value, obtaining the first sequence including at least one real value or including at least one complex value; wherein the real values of the second sequence are in one-to-one correspondence with the real values of the first sequence; or, the real values of the second sequence are combined two-by-two, and every two real values of the second sequence respectively correspond to a real part and an imaginary part of one complex value of the first sequence; in case the second sequence includes at least one binary value, de-quantizing or modulation mapping the binary value to obtain a third sequence including at least one real value or including at least one complex value, and based on the third sequence, obtaining the first sequence including at least one real value or including at least one complex value, wherein the real values of the third sequence are in one-to-one correspondence with the real values of the first sequence; or the real values of the third sequence are combined two-by-two, and every two real values of the third sequence respectively correspond to a real part and an imaginary part of one complex value of the first sequence; or the complex values of the third sequence are in one-to-one correspondence with the complex values of the first sequence.

According to the method of modulation symbol encryption in the communication system provided by the present disclosure, wherein the second sequence is obtained by: obtaining first information associated with one or more radio frequency characteristics of the user equipment; obtaining the second sequence based on the first information and a first correspondence, wherein the first correspondence includes a correspondence of a plurality of first ranges of the first information and a plurality of second sequences.

According to the method of modulation symbol encryption in the communication system provided by the present disclosure, wherein the method further comprises: receiving first configuration information from a network node, determining the one or more radio frequency characteristics from a first set including a plurality of radio frequency characteristics of the user equipment, based on the first configuration information, wherein the first configuration information includes at least one of: information associated with the one or more radio frequency characteristics; the first set; or the first correspondence.

According to the method of modulation symbol encryption in the communication system provided by the present disclosure, wherein the first configuration information is configured via first control information; or the first set is configured via higher layer signaling and the first configuration information is configured via second control information.

According to the method of modulation symbol encryption in the communication system provided by the present disclosure, wherein the encrypting the complex-valued modulation symbol sequence based on the first sequence to obtain the encrypted complex-valued modulation symbol sequence comprises: based on a correspondence of the first sequence to the complex-valued modulation symbol sequence, encrypting a phase and/or amplitude of the complex-valued modulation symbol sequence using the first sequence to obtain the encrypted complex-valued modulation symbol sequence.

According to the method of modulation symbol encryption in the communication system provided by the present disclosure, wherein the encrypting the phase of the complex-valued modulation symbol sequence using the first sequence to obtain the encrypted complex-valued modulation symbol sequence comprises: performing phase transformation (which can also be called phase rotation, phase shifting, etc.) on respective symbols of the complex-valued modulation symbol sequence based on a phase transformation value, to obtain the encrypted complex-valued modulation symbol sequence, wherein the phase transformation value is associated with at least one of: a real value, a real part of a complex value, an imaginary part of a complex value, or a phase of a complex value of a respective symbol in the first sequence.

According to the method of modulation symbol encryption in the communication system provided by the present disclosure, wherein the encrypting the amplitude of the complex-valued modulation symbol sequence using the first sequence to obtain the encrypted complex-valued modulation symbol sequence comprises: performing amplitude transformation on respective symbols of the complex-valued modulation symbol sequence based on an amplitude change value, to obtain the encrypted complex-valued modulation symbol sequence, wherein the magnitude change value is associated with at least one of: a real value, a real part of a complex value, an imaginary part of a complex value, or a phase of a complex value of a respective symbol in the first sequence.

According to the method of modulation symbol encryption in the communication system provided by the present disclosure, wherein the encrypting the phase and/or amplitude of the complex-valued modulation symbol sequence using the first sequence to obtain the encrypted complex-valued modulation symbol sequence comprises: performing a sum and/or a weighted sum on the complex-valued modulation symbol sequence and the first sequence including at least one complex value, to obtain the encrypted complex-valued modulation symbol sequence.

According to the method of modulation symbol encryption in the communication system provided by the present disclosure, wherein the method further comprises: transmitting second information to a network node, wherein the second information includes at least one of: information associated with an encrypted communication channel state; information associated with an encryption scheme and/or encryption weight desired by the UE; obtaining the encryption scheme and/or the encryption weight based on third information received from the network node including association with the encryption scheme and/or the encryption weight configured by the network node; wherein the encryption scheme includes at least one of: a phase-based encryption scheme, an amplitude-based encryption scheme, a phase and amplitude-based encryption scheme.

According to the method of modulation symbol encryption in the communication system provided by the present disclosure, wherein the encrypting the phase and/or amplitude of the complex-valued modulation symbol sequence using the first sequence to obtain the encrypted complex-valued modulation symbol sequence comprises: encrypting the complex-valued modulation symbol sequence based on the obtained encryption scheme and/or encryption weight using the first sequence, to obtain the encrypted complex-valued modulation symbol sequence.

According to the method of modulation symbol encryption in the communication system provided by the present disclosure, wherein the method further comprises: reading symbols of a stored first sequence from a circular buffer according to a starting position of the read circular buffer and/or an order of the read circular buffer, and sequentially encrypting respective symbols in the complex-valued modulation symbol sequence using the read symbols of the first sequence.

According to another aspect of the present disclosure, there is provided a user equipment UE comprising: a transceiver configured to transmit and/or receive a signal; and a controller configured to control the transceiver to perform the above-described method performed by the UE.

According to another aspect of the present disclosure, there is provided a base station comprising: a transceiver configured to transmit and/or receive signals; and a controller configured to control the transceiver to perform the above-described method performed by the network node.

According to another aspect of the present disclosure, there is provided a non-transitory computer-readable recording medium having stored thereon a program which, when being executed by a computer, performs any of the above methods.

The above-described various embodiments of the disclosure are merely some of the preferred embodiments of the disclosure, and various embodiments reflecting the technical features of the disclosure may be derived and understood by those skilled in the art based on the following detailed description of the disclosure.

The present application relates to the field of communications and, more particularly, to modulation symbol encryption method, user equipment and network node.

The effects that can be achieved through the disclosure are not limited to the effects mentioned in the various embodiments, and other effects not mentioned will be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of various wireless networks according to an embodiment of the present disclosure;

FIG. 2A illustrates a wireless transmission path according to embodiments of the present disclosure;

FIG. 2B illustrates wireless reception paths according to embodiments of the present disclosure;

FIG. 3A illustrates a user equipment according to an embodiment of the present disclosure;

FIG. 3B illustrates a base station according to an embodiment of the present disclosure;

FIG. 4 illustrates a complex-valued modulation symbol sequence obtained by QPSK modulation mapping according to an embodiment of the present disclosure;

FIG. 5 illustrates a phase transformation on complex-valued modulation symbols according to an embodiment of the present disclosure;

FIG. 6 illustrates amplitude scaling on complex-valued modulation symbols according to an embodiment of the present disclosure;

FIG. 7 illustrates simultaneous phase and amplitude encryption on complex-valued modulation symbols according to an embodiment of the present disclosure;

FIG. 8 illustrates decryption on a received encrypted complex-valued modulation symbol sequence [symbol] according to a phase according to an embodiment of the present disclosure;

FIG. 9 illustrates decryption on a received encrypted complex-valued modulation symbol sequence [symbol] according to an amplitude according to an embodiment of the present disclosure;

FIG. 10 illustrates decryption on a received encrypted complex-valued modulation symbol sequence [symbol] according to an amplitude and a phase according to an embodiment of the present disclosure;

FIG. 11 illustrates encryption according to different weights according to an embodiment of the present disclosure;

FIG. 12 illustrates a circular buffer according to an embodiment of the present disclosure;

FIG. 13 illustrates UE according to an embodiment of the present disclosure; and

FIG. 14 illustrates a network node according to an embodiment of the present disclosure.

### DETAILED DESCRIPTION

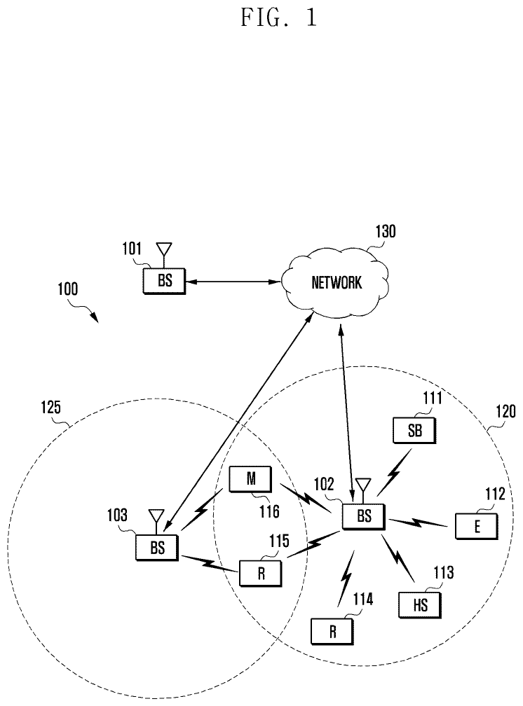

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In order to make the objectives, technical schemes and advantages of the embodiments of the present disclosure, a clearly and complete description will be made with respect to the technical schemes of the embodiments of the present disclosure, in conjunction with the accompanying drawings of the embodiments of the present disclosure. Apparently, the described embodiments are a part of the embodiments of the present disclosure, not all of the embodiments. Based on the described embodiments of the present disclosure, all other embodiments obtained by common skilled in the art without creative labor belong to the protection scope of the present disclosure. In the present disclosure, elements expressed in the singular form may also be understood to be expressed in the plural form. Similar words such as singular forms “a,” “an” or “the” do not express a limitation of quantity, but express the existence of at least one of the referenced item, unless the context clearly dictates otherwise. For example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect to or with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The function associated with any particular controller may be centralized or distributed, whether locally or remotely. The phrase “at least one of,” when used with a list of items, means that different combinations of one or more of the listed items may be used, and only one item in the list may be needed. For example, “at least one of the following: A, B, and C” includes any of the following combinations: A, B, C, A and B, A and C, B and C, and A and B and C. For example, “at least one of A, B, or C” includes any of the following combinations: A, B, C, A and B, A and C, B and C, and A and B and C.

In addition, various functions described below can be implemented or supported by one or more computer programs, each of which is formed by computer-readable program code and embodied in a computer-readable medium. The terms “application” and “program” refer to one or more computer programs, software components, instruction sets, procedures, functions, objects, classes, instances, related data or parts thereof appropriate for implementation in suitable computer-readable program code. The phrase “computer readable program code” includes any type of computer code, including source code, objective code and executable code. The phrase “computer readable medium” includes any type of medium that can be accessed by a computer, such as read-only memory (ROM), random access memory (RAM), hard disk drive, compact disk (CD), digital video disk (DVD) or any other type of memory. A “non-transitory” computer-readable medium excludes wired, wireless, optical or other communication links that transfer transitory electrical or other signals. A non-transitory computer-readable medium includes a medium in which data can be stored permanently and a medium in which data can be stored and rewritten later, such as rewritable optical disks or erasable memory devices.

The terms used herein to describe the embodiments of the present application is not intended to limit and/or define the scope of the present application. For example, unless otherwise defined, the technical or scientific terms used in the present disclosure should have common meanings as understood by common skilled in the art to which the present application belongs.

It should be understood that “first,” “second” and similar words used in the present disclosure do not indicate any order, quantity or importance, but are only used to distinguish different components. Unless clearly indicated otherwise in the context, similar words such as “a,” “an,” “the” and the like in the singular form do not indicate a quantitative limitation, but indicate the existence of at least one.

As used herein, any reference to “one example” or “an example,” “one embodiment” or “an embodiment” means that a particular element, feature, structure or characteristic described in conjunction with the embodiment is included in at least one embodiment. The appearances of the phrases “in one embodiment” or “in one example” in different places in the specification are not necessarily all referring to the same embodiment.

As used herein, “a part of” a certain thing means “at least some of” this thing, so it may mean being less than the entirety thereof or being the entirety thereof. Therefore, “a part of” the thing includes the whole thing as a special case, that is, an example in which the whole thing is a part of the thing.

It will be further understood that words such as “include,” “contain” or the like means that the elements or objects appearing preceding the word encompass the elements or objects listed behind the word as well as their equivalents, without excluding other elements or objects. Words such as “connect,” “interconnect” or the like are not limited to physical or mechanical connections, but may include electrical connection, whether direct or indirect. “Up,” “Down,” “Left” and “Right” are only used to indicate relative positional relationships. When the absolute position of the described object changes, accordingly, the relative positional relationship may change as well.

The various embodiments discussed below for describing the principle of the present disclosure in this patent document are for illustration only, and should not be construed as limiting the scope of the present disclosure in any way. Those skilled in the art will understand that the principle of the present disclosure may be implemented in any suitably arranged wireless communication system. For example, although the following detailed description of the embodiments of the present disclosure will focus on LTE and 5G communication systems, those skilled in the art can understand that the main points of the present disclosure can also be applied to other communication systems with similar technical backgrounds and channel formats, with slight modifications and basically without departing from the scope of the present disclosure. The schemes of the embodiments of the present application may be applied to various communication systems. For example, the communication systems may include a global system for mobile communications (GSM) system, a code division multiple access (CDMA) system, a wideband code division multiple access (WCDMA) system, general packet radio service (GPRS), long term evolution (LTE) system, LTE frequency division duplex (FDD) system, LTE time division duplex (TDD), universal mobile telecommunication system (UMTS), worldwide interoperability for microwave access (WiMAX) communication system, fifth generation (5th generation, 5G) system or new radio (NR), etc. In addition, the schemes of the embodiments of the present application may be applied to future-oriented communication technologies. In addition, the schemes of the embodiments of the present application may be applied to future-oriented communication technologies.

The following description with reference to the accompanying drawings is provided to assist in a comprehensive understanding of various embodiments of the present disclosure as defined by the claims and their equivalents. The description includes various specific details to assist in that understanding but should be regarded as exemplary only. Accordingly, the common skilled in the art will recognize that various changes and modifications to the various embodiments described herein can be made without departing from the scope and spirit of the present disclosure. In addition, descriptions of well-known functions and structures may be omitted for clarity and conciseness.

The terms and wordings used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only, but not for the purpose of limiting the present disclosure as defined by the appended claims and their equivalents.

It should be understood that the singular forms “a,” “an,” and “the” include plural referents, unless clearly indicated otherwise in the context. Thus, for example, reference to “a component surface” includes reference to one or more of such surfaces.

The term “include” or “may include” refers to the existence of a corresponding disclosed function, operation or component which can be used in various embodiments of the present disclosure, and does not limit the existence of one or more additional functions, operations, or components. The terms “include” and/or “have” may be construed to represent certain characteristics, numbers, steps, operations, constituent elements, components or combinations thereof, but may not be construed to exclude the possibility of existence of one or more other characteristics, numbers, steps, operations, constituent elements, components or combinations thereof.

The term “or” used in various embodiments of the present disclosure includes any of the listed terms or all combinations thereof. For example, “A or B” may include A, may include B, or may include both A and B.

Unless defined differently, all terms used in the present disclosure, including technical or scientific terms, have the same meanings as those understood by the skilled in the art as described in the present disclosure. Common terms as defined in a dictionary are to be interpreted to have meanings consistent with the context in the relevant technical field o, and are not to be interpreted ideally or excessively, unless clearly defined as such in the present disclosure.

The figures discussed below and various embodiments for describing the principle of the present disclosure in this patent document are only for illustration, and should not be interpreted as limiting the scope of the present disclosure in any way. Those skilled in the art will understand that the principle of the present disclosure may be implemented in any suitably arranged system or device.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB.” For convenience, the terms “gNodeB” and “gNB” are used in this patent document to refer to network infrastructure components that provide wireless access for remote terminals. And, depending on the type of the network, other well-known terms such as “mobile station,” “user station,” “remote terminal,” “wireless terminal” or “user apparatus” can be used instead of “user equipment” or “UE.” For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of user equipments (UEs) within a coverage area 120 of gNB 102. The first plurality of UEs include a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

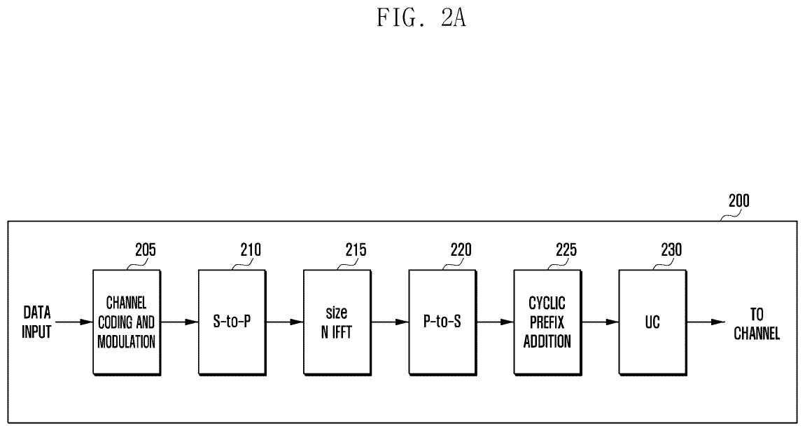

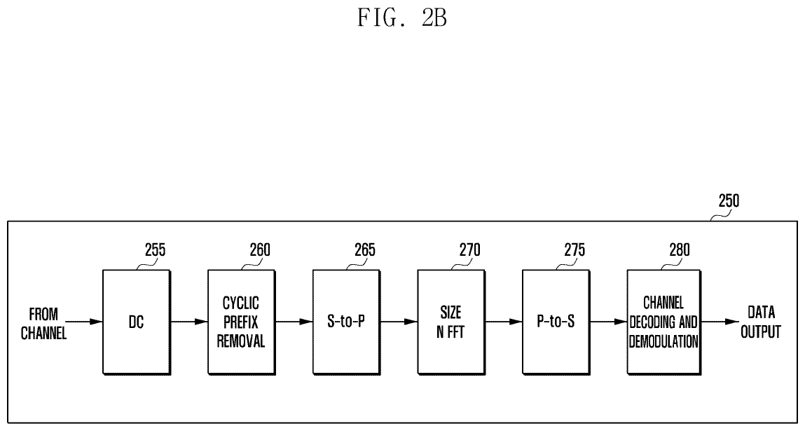

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

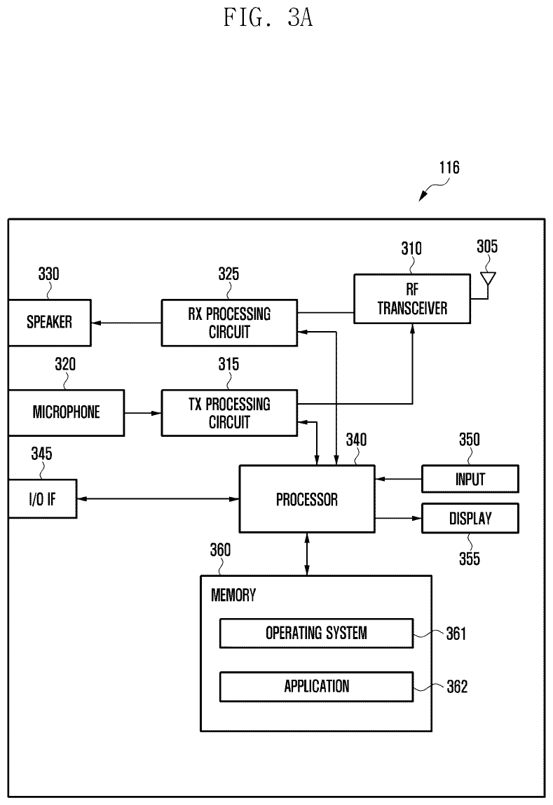

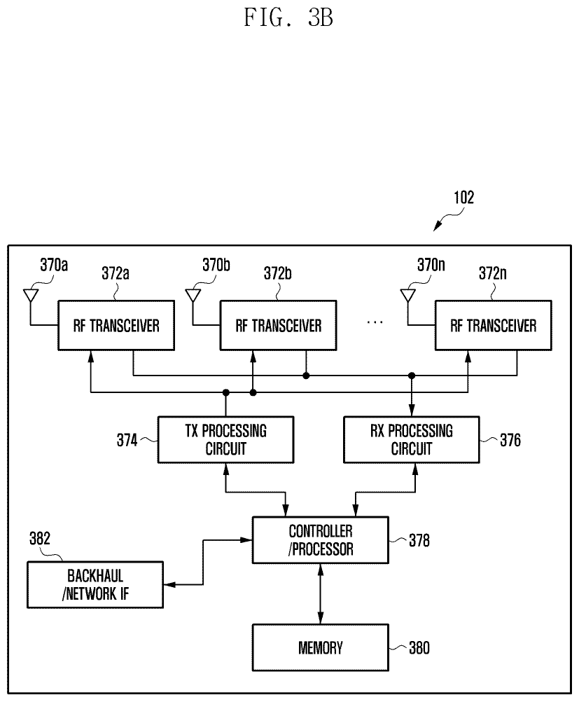

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as performed by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as performed by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The time domain unit (also called time unit) in this application can be: an OFDM symbol, an OFDM symbol group (composed of multiple OFDM symbols), a time slot, a time slot group (composed of multiple time slots), a subframe, a subframe group (composed of multiple subframes), a system frame and a system frame group (composed of multiple system frames). It can also be an absolute time unit, such as 1 millisecond, 1 second, etc. A time unit can also be a combination of various granularities, such as N1 time slots plus N2 OFDM symbols.

The frequency domain unit (also called frequency unit) in this application can be: a subcarrier, a subcarrier group (composed of multiple subcarriers), a resource block (RB), which can also be called a physical resource block (PRB), a resource block group (composed of multiple RBs), a bandwidth part (BWP), a bandwidth part group (composed of multiple BWPs), a bandwidth/carrier, and a bandwidth group/carrier group. It can also be an absolute frequency domain unit, such as 1 Hz, 1 kHz, etc. The frequency domain unit can also be a combination of multiple granularities, such as M1 PRBs plus M2 subcarriers.

Exemplary embodiments of the present disclosure are further described below with reference to the accompanying drawings.

Text and drawings are provided as examples only to help readers understand the present disclosure. They are not intended and should not be construed to limit the scope of the present disclosure in any way. Although certain embodiments and examples have been provided, based on the disclosure herein, it is obvious to those skilled in the art that changes can be made to the illustrated embodiments and examples without departing from the scope of this disclosure.

It can be understood by those skilled in the art that the singular forms “a,” “an,” “the” and “the” used herein can also include plural forms unless specifically stated. It should be further understood that the word “comprising” used in the specification of this application refers to the presence of said features, integers, steps, operations, elements and/or components, but does not exclude the presence or addition of one or more other features, integers, steps, operations, elements, components and/or groups thereof. It should be understood that when an element is “connected” or “coupled” to another element, it can be directly connected or coupled to the other element, or intervening elements may also exist. Furthermore, “connected” or “coupled” as used herein may include wireless connection or wireless coupling. As used herein, the phrase “and/or” includes all or any unit and all combinations of one or more associated listed items.

It can be understood by those skilled in the art that unless otherwise defined, all terms (including technical terms and scientific terms) used herein have the same meaning as commonly understood by those skilled in the art to which this application belongs. It should also be understood that terms, such as those defined in general dictionaries, should be understood to have meanings consistent with those in the context of the prior art, and will not be interpreted in an idealized or overly formal sense unless they are specifically defined as here.

It can be understood by those skilled in the technical field that the “terminal” and “terminal equipment” used here include both the equipment of wireless signal receiver, which only has the equipment of wireless signal receiver without transmission capability, and the equipment of receiving and transmitting hardware, which has the equipment of receiving and transmitting hardware capable of bidirectional communication on the bidirectional communication link. Such devices may include a cellular or other communication device having a single-line display or a multi-line display or a cellular or other communication device without a multi-line display. Personal communications (PC) service, which can combine voice, data processing, fax and/or data communication capabilities. Personal digital assistant (PDA), which may include RF receiver, pager, Internet/Intranet access, web browser, notepad, calendar and/or Global positioning system (GPS) receiver; a conventional laptop and/or palmtop computer or other device having and/or including a conventional laptop and/or palmtop computer or other device of a radio frequency receiver. As used herein, “terminal” and “terminal equipment” can be portable, transportable, installed in vehicles (air, sea and/or land), or suitable and/or configured to operate locally, and/or operate in any other location on the earth and/or space in a distributed form. The “terminal” and “terminal equipment” used here can also be communication terminals, internet terminals and music/video playing terminals, such as PDA, mobile internet device and/or mobile phone with music/video playing function, as well as smart TV, set-top box and other devices.

Without departing from the scope of the present disclosure, the term “send” in the present disclosure can be used interchangeably with “transmission,” “report” and “notification.”

Text and drawings are provided as examples only to help readers understand the present disclosure. They are not intended and should not be construed to limit the scope of the present disclosure in any way. Although certain embodiments and examples have been provided, based on the disclosure herein, it is obvious to those skilled in the art that changes can be made to the illustrated embodiments and examples without departing from the scope of this disclosure.

In cellular wireless communication systems (including 2G, 3G, 4G, and 5G), confidential messages are easily intercepted by malicious users due to the broadcast characteristics of the wireless transmission, resulting in a relatively weak security of the system. How to improve the security of wireless transmissions becomes a problem to be solved.

The 4G/5G system acquires a baseband signal based on an orthogonal frequency division multiplexing (OFDM) waveform, and the specific process includes: mapping a bit sequence to a complex-valued modulation symbol sequence through a modulation map; obtaining a frequency-domain OFDM baseband signal according to the complex-valued modulation symbol sequence.

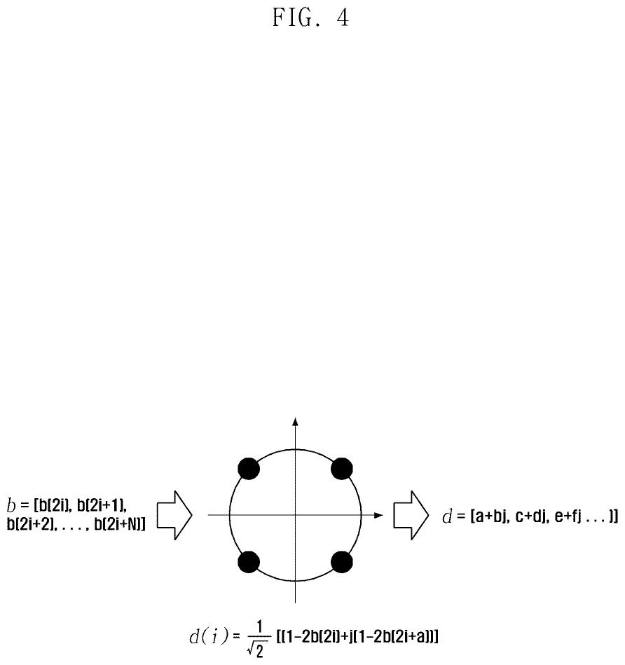

FIG. 4 illustrates a method for mapping a bit sequence to a complex-valued modulation symbol sequence with a quadrature phase shift keying (QPSK) modulation scheme. Herein, b represents the bit sequence, b(2i) represents the 2i-th bit in the bit sequence b, d represents the complex-valued modulation symbol sequence, wherein a +bj represents a first complex-valued modulation symbol in the sequence d, and a and b are the real and imaginary parts, respectively, of the complex-valued modulation symbol. The modulation mapper method described above is a public method, so that a malicious user can receive a signal by the same process as a legitimate receiver and demodulate each complex-valued modulation symbol, thereby intercepting a confidential message.

Embodiments of the present disclosure provide a method of modulation symbol encryption in a communication system, comprising: obtaining a first sequence for encrypting a complex-valued modulation symbol sequence based on a second sequence, wherein the second sequence is associated with a root key sequence or a secondary key sequence, or with a radio frequency characteristic of a user equipment; encrypting the complex-valued modulation symbol sequence based on the first sequence to obtain an encrypted complex-valued modulation symbol sequence; obtaining a baseband signal based on the encrypted complex-valued modulation symbol sequence.

By the method of modulation symbol encryption in the communication system provided by the present disclosure, it is possible to achieve that the complex-valued modulation symbols are encrypted according to the key (i.e., the first sequence), that only the receiver knowing the key can correctly demodulate the received complex-valued modulation symbols, and that the malicious user not knowing the key cannot correctly demodulate the received complex-valued modulation symbols. The present disclosure may enable security protection of a communication link at the physical layer.

Embodiments of the present disclosure will be described in detail below in conjunction with the accompanying drawings.

Embodiment 1: In one embodiment of the present disclosure, a method and device for performing communication encryption in an OFDM communication system, which determines an encryption sequence based on system configuration information, and then encrypts complex-valued modulated symbols according to the resulting encryption sequence during communication, thereby achieving the communication encryption, will be described.

The encryption sequence acquisition procedure in the communication system in the present disclosure may occur in a user equipment (UE) or a network device. The communication encryption process in the communication system of the present disclosure may include two parts, i.e., the transmitting end encrypts the signal and the receiving end decrypts the signal. The communication encryption method may be used for general transmission and/or reception of downlink data, and/or general transmission and/or reception of uplink data.

The method provided by the present disclosure may include one or a combination of the following operations:

A user equipment or a network device (e.g., a base station or the like) obtains an encrypted sequence f1 (which may also be referred to as a first sequence) for encrypting complex-valued modulated symbols according to a pre-encryption sequence f2 (which may also be referred to as a second sequence), in particular comprising one or more of the following:
The user equipment obtains the pre-encryption sequence f2 according to configuration information (e.g., radio resource control information (RRC)) and/or control information (e.g., downlink control information (DCI)), in particular comprising one or more of the following:
   obtaining a pre-encryption sequence f2 according to the configuration information;
   obtaining a pre-encryption sequence f2 according to the control information; and/or
   obtaining a set of pre-encryption sequences containing no less than one pre-encryption sequence according to the configuration information, and obtaining the pre-encryption sequence f2 from the set according to the control information;
Herein the pre-encryption sequence f2 may be at least one of:
   A binary key sequence f2 obtained by a higher layer functional entity (e.g., security functional entity, SF), which may be a root key sequence of the system (which may be referred to as encryption key K), or a secondary key sequence generated by the root key sequence, wherein the secondary key sequence includes, but is not limited to, a sequence applied to authentication credential repository and processing function (ARPF), authentication server function (AUSF), security anchor function (SEAF), access and mobility management function (AMF), subscription identifier de-concealing function (SIDF), unified data management (UDM), non-access stratum signaling (NAS signaling), next-generation radio access network (NG-RAN), uplink traffic (UP traffic), radio resource control signaling (RRC signalling) and non-3GPP access; and
   A pre-encryption sequence f2 containing no less than one user equipment's signal characteristic (also referred to as radio frequency characteristic, radio frequency feature, radio frequency fingerprint, radio frequency fingerprint characteristic, radio frequency fingerprint feature, etc.) indicators, wherein each signal characteristic indicator may be characterized by a real number, and the signal characteristic indicator includes, but not limited to, power amplifier nonlinearity characteristic indicator, phase noise characteristic indicator, frequency offset characteristic indicator, fractal characteristic indicator, constellation characteristic indicator, high-order moment characteristic indicator, spectrum characteristic indicator, envelope characteristic indicator, information dimension characteristic indicator, box dimension characteristic indicator, signal-to-noise ratio characteristic indicator, etc. of the system; and/or
Obtain the encrypted sequence f1 for encrypting the complex-valued modulation symbols according to the pre-encryption sequence f2, wherein the method of obtaining the encrypted sequence f1 may be:
   In case that the pre-encryption sequence f2 contains not less than one real value, the encrypted sequence f1 containing not less than one real value is obtained from the pre-encryption sequence f2;
   In case that the pre-encryption sequence f2 contains not less than two real values, the real values in the pre-encryption sequence f2 are paired two by two, and the paired two real values are used as a real part and an imaginary part of one complex value, respectively, to construct a complex-valued modulation symbol encrypted sequence f1 including not less than one complex value, and the encrypted sequence f1 containing not less than one complex value is obtained according to the complex values;
   In case that the pre-encryption sequence f2 contains not less than one binary number, the binary numbers in f2 are dequantized to obtain not less than one real value, and the encrypted sequence f1 containing not less than one real value is obtained according to the real value;
   In case that the pre-encryption sequence f2 contains not less than two binary numbers, the binary numbers in f2 are dequantized to obtain not less than two real values, the obtained real values are paired two by two, and the paired two real values are used as a real part and an imaginary part of one complex-valued encryption symbol, and the encrypted sequence f1 containing not less than one complex value is obtained according to the complex values; and/or
   In case that the pre-encryption sequence f2 contains not less than two binary numbers, modulation mapping is performed on the binary numbers in f2 to obtain at least one complex value, and the encrypted sequence f1 containing not less than one complex value is obtained according to the complex values.

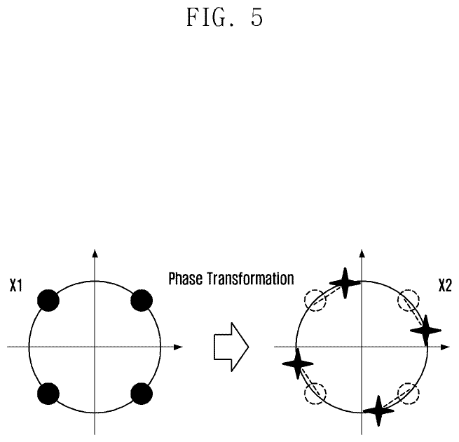

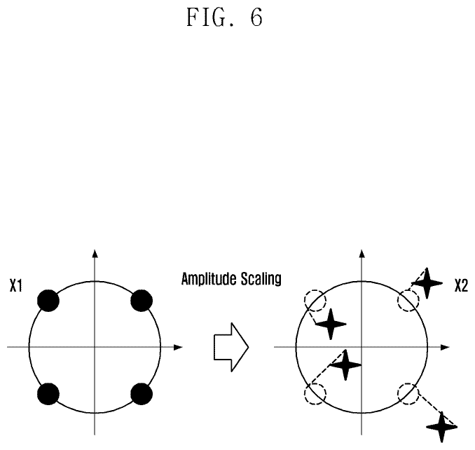

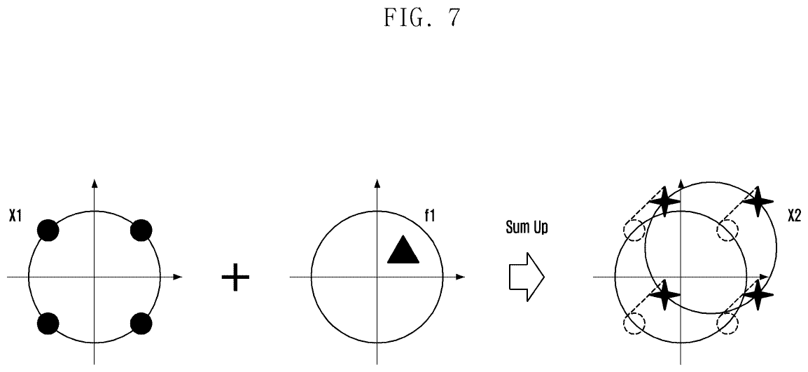

The user equipment or the network device obtains an encrypted complex-valued modulation symbol sequence x2, according to a complex-valued modulation symbol sequence x1 carrying data and/or system information and an encryption sequence f1 for encrypting the complex-valued modulation symbols, in particular comprising one or more of:
determining, by the user equipment, a correspondence of the encryption sequence f1 for encrypting the complex-valued modulation symbols and the complex-valued modulation symbol sequence x1 as indicated by the configuration information, the indication signal indicating a combination comprising one or more of:
   a start symbol index of the encrypted sequence f1;
   an indication of repetition of the encryption sequence f1 for determining an encryption correspondence when the length of x1 is greater than the length of f1; and/or
   an indication of truncation of the encryption sequence f1 for determining an encryption correspondence when the length of x1 is less than the length of f1;
The user equipment or the network device encrypts each symbol in the complex-valued modulation symbol sequence x1 according to the correspondence of the encryption sequence f1 for encrypting the complex-valued modulation symbols and the complex-valued modulation symbol sequence x1, the method of encrypting may be an adjustment of a phase and/or an amplitude of the complex-valued modulation symbols in the complex-valued modulation symbol sequence x1 according to the encryption sequence f1 for encrypting the complex-valued modulation symbols, the method of adjusting may be at least one of the following:
   Phase transformation is performed on each complex-valued modulation symbol in the complex-valued modulation symbol sequence x1 according to the corresponding symbols in the encryption sequence f1. An illustration of performing the phase transformation on each complex-valued modulation symbol in a complex-valued modulation symbol sequence x1 according to a corresponding symbol in an encrypted sequence f1 is shown in FIG. 5, the method of the phase transformation is x2(i)=x1(i)* [symbol] , wherein x2(i) characterizes the i-th symbol in the sequence x2, x1(i) characterizes the i-th symbol in the sequence x1, and [symbol] (i) is the value of the phase transformation applied to the i-th symbol in the sequence x1, [symbol] is is determined by the corresponding symbol in the encryption sequence f1 for encrypting the complex-valued modulation symbols, the method of the determining may be:
      When the corresponding symbol is a real value, the value of the phase transformation is the real value; and/or
      When the corresponding symbol is a complex value, the value of the phase transformation may be the real part, the imaginary part, the phase of the corresponding complex value;
   Amplitude scaling is performed on each complex-valued modulation symbol in the complex-valued modulation symbol sequence x1 according to the corresponding symbols in the encryption sequence f1. An illustration of performing the amplitude scaling on each complex-valued modulation symbol in a complex-valued modulation symbol sequence x1 according to a corresponding symbol in an encrypted sequence f1 is shown in FIG. 6, the method of the amplitude scaling is x2(i)=x1(i)* [symbol] (i), where x2(i) characterizes the i-th symbol in the sequence x2, x1(i) characterizes the i-th symbol in the sequence x1, and [symbol] is the value of the amplitude scaling applied to the i-th symbol in the sequence x1, [symbol] is determined by the corresponding symbol in the encryption sequence f1 for encrypting the complex-valued modulation symbols, the method of the determining may be:
      When the corresponding symbol is a real value, the value of the amplitude scaling is real-valued; and/or
      When the corresponding symbol is a complex value, the value of the amplitude scaling may be the real part, the imaginary part, the amplitude of the corresponding complex value; and/or
   Phase encryption and amplitude encryption are simultaneously performed on each complex-valued modulation symbol in the complex-valued modulation symbol sequence x1 according to the corresponding symbols in the encryption sequence f1. An illustration of simultaneously performing the phase encryption and amplitude encryption on each complex-valued modulation symbol in a complex-valued modulation symbol sequence x1 according to a corresponding symbol in an encryption sequence f1 is shown in FIG. 7, the method of encryption is to perform a sum on each complex-valued modulation symbol in the complex-valued modulation symbol sequence x1 and the corresponding symbols in the encryption sequence f1, this can be specifically expressed using the formula x2(i)=x1(i)+f1(i), wherein x2(i) represents the i-th symbol in the sequence x2, x1(i) represents the i-th symbol in the sequence x1, and the symbol in f1 is a complex value.

The user equipment or the network device obtains an encrypted baseband signal based on the encrypted complex-valued modulation symbol sequence;
Preferably, before obtaining the encrypted baseband signal, power normalization is first performed on the encrypted sequence x2, and then the generation of the baseband signal is performed.

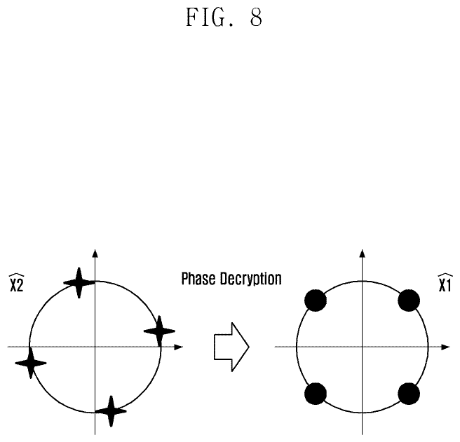

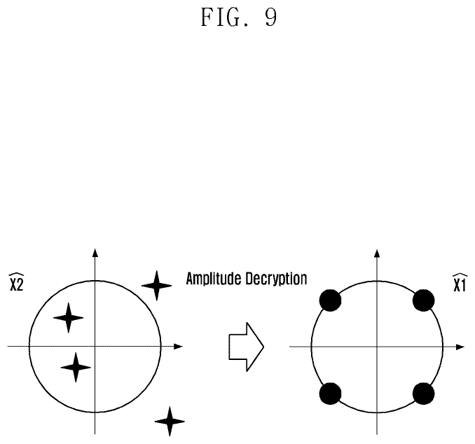

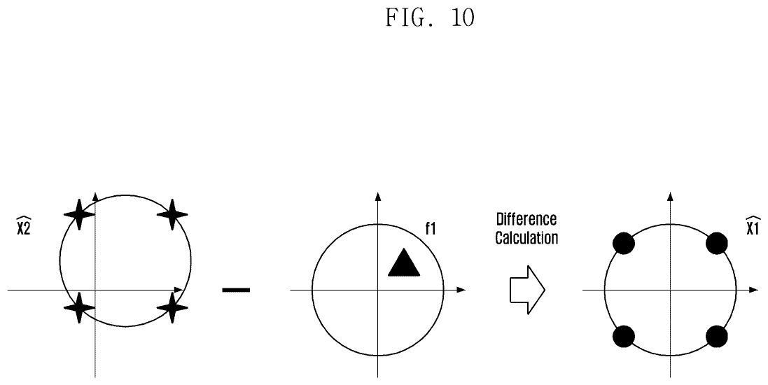

The user equipment or network device recovers a complex-valued modulation symbol sequence [symbol] carrying data and/or system information, according to the received encrypted complex-valued modulation symbols sequence [symbol] , in particular including one or more of:
The user equipment determines a correspondence of the encryption sequence f1 for encrypting the complex-valued modulation symbols and the complex-valued modulation symbol sequence [symbol] , according to the indication of the configuration information, which indication signal is similar to the previous indication signal for determining the correspondence of f1 and x1, which is not described in detail here; and/or.
The user equipment or the network device decrypts each symbol in the received encrypted complex-valued modulation symbol sequence [symbol] according to the correspondence. The method of decryption is determined according to the configuration, and corresponds to the encryption method for obtaining x2, in particular the method of decryption may be at least one of:
   Phase transformation is performed on each complex-valued modulation symbol in the received encrypted complex-valued modulation symbol sequence [symbol] according to the corresponding symbols in the encryption sequence f1. An illustration of the decryption of the received encrypted complex-valued modulation symbol sequence [symbol] according to the phase is shown in FIG. 8. The method of phase transformation is [symbol] (i) = [symbol] (i)*e^{j2πf1(i)}, wherein acquisition method of [symbol] is similar to that before and will not be described in detail here;
   Amplitude scaling is performed on each complex-valued modulation symbol in the received encrypted complex-valued modulation symbol sequence [symbol] according to the corresponding symbols in the encryption sequence f1. An illustration of the decryption of the received encrypted complex-valued modulation symbol sequence [symbol] according to the amplitude is shown in FIG. 9. The method of amplitude scaling is [symbol] (i)= [symbol] (i)/f1(i), wherein acquisition method of [symbol] is similar to that before and will not be described in detail here; and/or
   Phase decryption and amplitude decryption are simultaneously performed on each complex-valued modulation symbol in the received encrypted complex-valued modulation symbol sequence [symbol] according to the corresponding symbols in the encryption sequence f1. An illustration of decryption of each complex-valued modulation symbol in the received encrypted complex-valued modulation symbol sequence [symbol] according to the phase and the amplitude is shown in FIG. 10. The method of decryption is to perform a difference on each symbol in the received encrypted complex-valued modulation symbol sequence xl and the corresponding symbols in the encryption sequence f1, which may be obtained in accordance with the formula [symbol] (i)= [symbol] (i)−f1(i).

### Embodiment 2: Dynamic Encryption Sequence Generation Based on Radio Frequency Characteristic

The user equipment sends an uplink signal (using as an example a sounding reference signal, SRS, but may alternatively be another uplink signal, such as physical random access channel (PRACH) to the network device, and the network device obtains a radio frequency fingerprint characteristic set r1 (which may also be referred to as a first set) of the user equipment, in particular comprising one or more of the following:
The user equipment obtains resource configuration information from the network device to configure the SRS, e.g., including a time domain starting position, a length of time domain unit, a frequency domain resource starting position, a length of frequency domain unit, periodicity, etc.;
The user equipment transmits SRS signals on the available configured resources, which can be either base station assigned or randomly selected by the UE in one SRS resource pool; and/or
The network device obtains the radio frequency fingerprint characteristic set r1 of the user equipment by receiving the SRS signal, wherein the radio frequency fingerprint characteristic set r1 contains the radio frequency signature values in a similar manner as before, and will not be described in detail herein.

The user equipment obtains a pre-encryption sequence f2 according to a set r1 of configuration information (e.g., radio resource management information (RRC)) and own signal characteristics (also referred to as radio frequency characteristics, radio frequency fingerprint characteristics, etc.), wherein f2 may be used for encrypting encryption sequence f1 of the complex-valued modulation symbols, wherein the method of obtaining the pre-encryption sequence f2 comprises one or more of the following:
The user equipment extracts its own set of signal characteristics r1 from a local memory;
The user equipment obtains the indication signaling related to the encryption sequence f1 acquisition from the network device configuration, wherein the indication signaling may be included in the configuration information, e.g., radio resource management information (RRC), which indication signaling indicates a combination comprising one or more of:
   A signal characteristic indication related to the encrypted sequence f2 for indicating not less than one signal characteristic;
   A set of pre-encryption sequences s1 including no less than one pre-defined encryption sequence for encrypting complex-valued modulation symbols; and/or
   A correspondence t1 (e.g., t1 may be a table including the correspondence) of the encryption sequences in the set of pre-encryption sequences s1 and the signal characteristic correlation index, for selecting the encrypted sequence from s1 according to the signal characteristic correlation index of the user equipment;
The method to acquire f2 by the user equipment may be that the pre-encryption sequence f2 is obtained according to a signal characteristic indication related to the encrypted sequence f2 and a radio frequency fingerprint characteristic set r1, the signal characteristic indication may be included in control information (e.g., downlink control information (DCI)), and the specific acquisition method may include at least one of the following:
   determining not less than one signal characteristic based on the configured signal characteristic indication related to the encrypted sequence f2;
   extracting indexes of the signal characteristics [r1(i), r1(i+1), . . . ] from the set of radio frequency fingerprint features r1 of the user equipment; and/or
   obtaining the pre-encryption sequence f2 according to the indexes [r1(i), r1(i+1), . . . ], the kinds of the signal characteristics contained in r1 are similar as before, which are not repeated here; and/or
The method to acquire f2 by the user equipment also may be that the pre-encryption sequence f2 is obtained according to the signal characteristic indication related to the encrypted sequence f2, the set of radio frequency fingerprint characteristics r1, the set of pre-encryption sequences s1, and the correspondence t1, wherein the method of acquiring comprises at least one of the following:
   determining not less than one signal characteristic based on the configured signal characteristic indication related to the encrypted sequence f2;
   extracting indexes of the signal characteristics [r1(i), r1(i+1), . . . ] from the set of radio frequency fingerprint features r1 of the user equipment; and/or
   obtaining an encryption sequence indication index z (which may also be referred to as first information) from the indexes of signal characteristics [r1(i), r1(i+1), . . . ], the method comprising at least one of:
      normalizing the indexes of the signal characteristics [r1(i), r1(i+1), . . . ]; and/or
      weighted averaging the indexes of the signal characteristics [r1(i), r1(i+1), . . . ]; and/or
   obtaining an encrypted sequence f2 from the set of pre-encryption sequences s1 according to a correspondence t1 (which may also be referred to as a first correspondence) of the encryption sequence indication index and the encrypted sequence, wherein the set of pre-encryption sequences s1 and the correspondence may be obtained by the user equipment by receiving a network configuration or may be pre-defined; for example, the correspondence is illustrated in the following table, the range of obtained encryption sequence indication index z is between z1 and z2, the user equipment uses the encrypted sequence s1(2) as the pre-encryption sequence f2.

| encryption sequence indication | |
|---|---|
| index z range (may also be | |
| referred to as first range) | the set of encrypted sequences s1 |
| z1-z2 | encryption sequence s1 (1) |
| z3-z4 | encryption sequence s1 (2) |
| . . . | . . . |
| zN-1 to zN | encrypted sequence s1 (N/2) |

### Embodiment 3: Encryption Method Configurable Based on Security Level

The user equipment encrypts a complex-valued modulation symbol sequence x1 carrying data and/or system information based on an encryption sequence f1, according to the configuration information, to obtain an encrypted complex-valued modulation symbol sequence x2, in particular the encryption method comprising one or more of:
The user equipment reports signaling (which may also be referred to as second information) related to the encrypted communication requirement to the network device, the signaling being indicative of a combination comprising one or more of:
   encrypted communication channel state information for indicating a maximum degree of encryption that can be supported by the current channel state; and/or
   an encrypted communication scheme index for indicating an encrypted communication scheme desired by the user equipment;
The user equipment obtains encrypted communication indication signaling from a network device configuration, the indication signaling indicating a combination comprising one or more of:
   an encrypted communication scheme index (which may also be referred to as third information) for indicating the method used to encrypt the communication, including but not limited to: phase-based encryption, amplitude-based encryption, phase and amplitude-based encryption;
   an encryption weights sequence A for the encrypted communication, which includes no less than one encryption weight therein [α1, α2 . . . ]
   preferably, the encrypted communication scheme index may be used to indicate the method used to encrypt the communication and the corresponding weight;
   an indication that encrypted communication is enabled or encrypted communication is ended;
   a timer length for the encrypted communication, the timer started when the encrypted communication activation indication signal is received by the user equipment; and/or
   a counter (counter) of encrypted communication, including a maximum number of encrypted communication (counter_max), with an initial counter value of 0; the counter is incremented by one (counter +1) when the user equipment sends an encrypted uplink signal once and/or receives an encrypted downlink signal once, and when counter=counter_max, the user equipment terminates encrypted communication;
The user equipment determines an encrypted communication scheme based on the encrypted communication scheme indication signaling configured by the network device and a correspondence (which may also be referred to as a second correspondence) of the encrypted communication scheme and an encrypted communication scheme index, wherein the correspondence may be obtained by the user equipment by receiving the network configuration or may be defined in advance; the correspondence is exemplified by the following table, wherein the user equipment obtains an encrypted communication scheme including an encryption scheme that is phase encryption and an encryption weight that is α(1, 3) according to the encrypted communication scheme index 2 indicated in the signaling, and uses the encrypted communication scheme in the subsequent reception of a downlink signal and/or transmission of an uplink signal according to the indicated encrypted communication scheme;

| encryption | | |
|---|---|---|
| scheme index | encryption scheme | encryption weight |
| 0 | phase Encryption | α (1, 1) |
| 1 | phase Encryption | α (1, 2) |
| 2 | phase Encryption | α (1, 3) |
| . . . | . . . | . . . |
| n − 1 | | α (1, n − 1) |
| n | amplitude encryption | α (2, 1) |
| n + 1 | amplitude encryption | α (2, 2) |
| n + 2 | amplitude encryption | α (2, 2) |
| . . . | . . . | . . . |
| n + m − 1 | amplitude encryption | α (2, m) |
| n + m | phase and amplitude | [α(3, 1), α(4, 1)] |
| | encryption | |
| n + m + 1 | phase and amplitude | [α(3, 2), α(4, 2)] |
| | encryption | |
| n + m + 2 | phase and amplitude | [α(3, 3), α(4, 3)] |
| | encryption | |
| . . . | . . . | . . . ; |

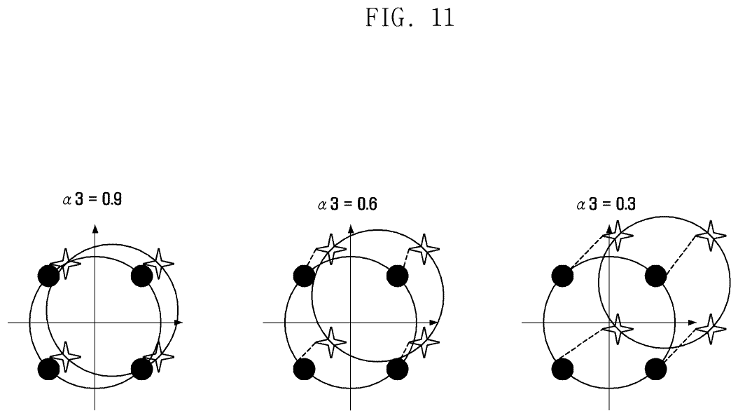

and/or
The user equipment encrypts each symbol in the complex-valued modulation symbol sequence x1 according to the determined encrypted communication scheme and the encryption sequence f1, in particular the method of the encryption may be at least one of the following:
   Phase transformation is performed on each complex-valued modulation symbol in the complex-valued modulation symbol sequence x1 according to the corresponding symbols in the encryption sequence f1 and encryption weight α(1,1). The method of the phase transformation is x2(i)=x1(i)* [symbol] , wherein acquisition method of [symbol] is similar to that before and will not be described in detail here.
   Amplitude scaling is performed on each complex-valued modulation symbol in the complex-valued modulation symbol sequence x1 according to the corresponding symbols in the encryption sequence f1 and encryption weight α(2,1). The method of the amplitude scaling is x2(i) =α(2,1)*x1(i) [symbol] (i), wherein acquisition method of [symbol] is similar to that before and will not be described in detail here; and/or
   Phase encryption and amplitude encryption are simultaneously performed on each complex-valued modulation symbol in the complex-valued modulation symbol sequence x1 according to the corresponding symbols in the encryption sequence f1 and encryption weight [α(3, 1), α(4, 1)]. An illustration of performing the encryption according to the different weight is shown in FIG. 11, the method of encryption is to perform a weighted sum on each complex-valued modulation symbol in the complex-valued modulation symbol sequence x1 and the corresponding symbols in the encryption sequence f1, this can be specifically expressed using the formula x2(i)=α(3,1)x1(i)+α(4,1)f1(i):
      Preferably, α(3,1)=1−α(4,1) is configured to ensure that the total power of each symbol in the encrypted sequence x2 is consistent with x1.

### Embodiment 4: Mapping Method of Complex-valued Modulation Symbol Sequence x1 and Encrypted Sequence f1

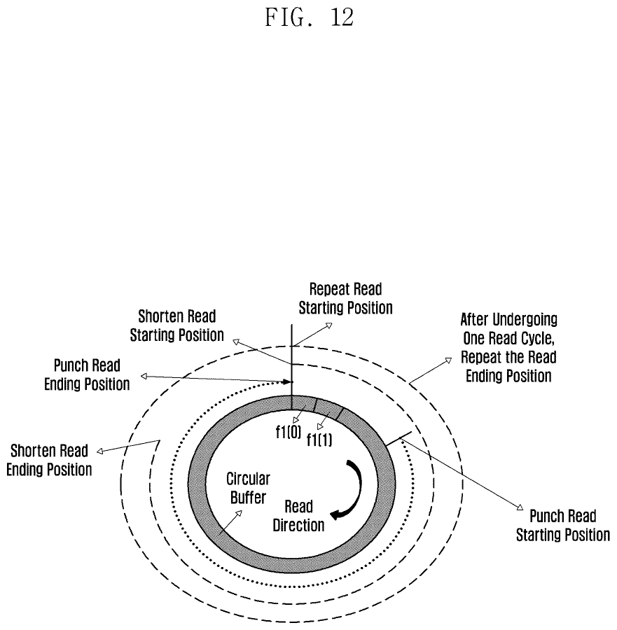

The user equipment or the network device encrypts each symbol in the complex-valued modulation symbol sequence x1 according to a correspondence of an encrypted sequence f1 of encrypted complex-valued modulation symbols and the complex-valued modulation symbol sequence x1, the method of encrypting according to the correspondence comprising one or more of:
determining, by the user equipment, a correspondence of an encryption sequence f1 for encrypting the complex-valued modulation symbols and a complex-valued modulation symbol sequence x1 as indicated by the configuration information, the indication signal indicating a combination comprising one or more of:
   a scheme indication of cryptographic correspondence, for indicating how f1 and x1 correspond to each other when they are not the same length, the scheme may include at least one of the following:
      repetition, when the length of f1 is smaller than the length of x1, the correspondence to x1 is achieved by repeating f1;
      puncture, when the length of f1 is greater than the length of x1, the correspondence to x1 is achieved by deleting the portion of f1 from the beginning and selecting a portion of f1 with equal length to x1; and/or
      shortening, when the length of f1 is greater than x1, the correspondence to x1 is achieved by deleting the portion of f1 from the ending and selecting a portion of f1 with equal length to x1;
   a starting position to read a circular buffer; and/or
   an order to read a circular buffer;
The user equipment or the network device writes the symbols in the encrypted sequence f1 in order into a Circular buffer, wherein the length of the Circular buffer is equal to the number of symbols in the encrypted sequence f1, an illustration of which is shown in FIG. 12; and/or
The user equipment or the network device sequentially reads symbols for encryption from the circular buffer according to the configured starting position to read a circular buffer and the order to read a circular buffer, and encrypts the read encrypted symbols with the corresponding complex-valued modulation symbols in the complex-valued modulation symbol sequence x1; for example, storing f1=[f1(0), f1(1), f1(2), . . . f1(N)] into a circular buffer, and receiving configuration information including the starting position to read a circular buffer of 1 and the read order of positive order read, then encrypting x1=[x1(0), x1(1), x1(2), . . . , x1(M)] is encrypting a two-by-two combination of f1(t) and x1(t−1), where N>M; taking the encryption method as amplitude scaling as an example, the encrypted sequence x2 may be represented as x2=[f1(1)*x1(0), f1(2)*x1(1), f1(3)*x1(2), . . . , f1(M+1)*x1(M)].

In an embodiment of the present disclosure, the configuration information includes at least one of base station configured, indicated in the received signaling, higher layer configured, preconfigured information, if no special description is made. Further, it may be a set of configuration information obtained by the above method; and it may also be multiple sets of configuration information obtained by the above method, from which the UE or node may select a set of configuration information to use according to a predefined condition; it may also be a set of configuration information obtained by the above method, and the set of configuration information includes a plurality of subsets from which the UE or node may select a subset for use according to a predefined condition.

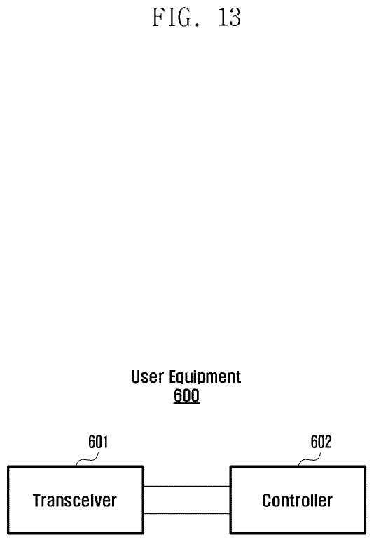

FIG. 13 illustrates a structure of a user equipment 600 according to an embodiment of the present disclosure. Referring to FIG. 13, a user equipment 600 includes a transceiver 601 and a controller 602. The transceiver 601 is configured to transmit and receive signals to and from the outside. The controller 602 is configured to perform the method performed by the user equipment described above. The user equipment 600 may be implemented in the form of hardware, software, or a combination of hardware and software, so as to enable it to perform the method performed by the user equipment described in the present disclosure.

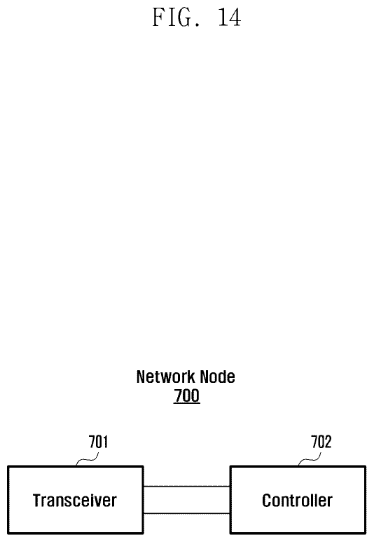

FIG. 14 illustrates a structure of a base station 700 according to an embodiment of the present disclosure.

Referring to FIG. 14, a base station 700 includes a transceiver 701 and a controller 702. The transceiver 701 is configured to transmit and receive signals to and from the outside. The controller 702 is configured to perform the method performed by the base station described above. The base station 700 may be implemented in the form of hardware, software, or a combination of hardware and software, so that it can perform the method described by the base station in this disclosure.

Those skilled in the art will understand that the illustrative embodiments described above are described herein and are not intended to be limiting. It should be understood that any two or more of the embodiments disclosed herein can be combined in any combination. In addition, other embodiments can be utilized and other changes can be made without departing from the spirit and scope of the subject matter presented herein. It will be readily understood that aspects of the present disclosure of the present disclosure, as generally described herein and shown in the accompanying drawings, can be arranged, substituted, combined, separated and designed in various different configurations, all of which are contemplated herein.

Those skilled in the art will understand that the various illustrative logical blocks, modules, circuits, and steps described in the present application can be implemented as hardware, software, or a combination of both. In order to clearly illustrate this interchangeability between hardware and software, various illustrative components, blocks, modules, circuits, and steps are generally described above in the form of their function set. Whether such a function set is implemented as hardware or software depends on the specific application and the design constraints imposed on the overall system. Skilled people can implement the described function set in different ways for each specific application, but such design decisions should not be interpreted as causing a departure from the scope of the present application.

The various illustrative logic blocks, modules, and circuits described in the present application can be implemented in a general-purpose processor, a digital signal processor (DSP), an application specific integrated circuit (ASIC), a field programmable gate array (FPGA) or other programmable logic devices, discrete gate or transistor logic, discrete hardware component, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of the method or technique described in the present application can be embodied directly in hardware, in a software module executed by a processor, or in a combination of both. Software modules may reside in RAM memory, flash memory, ROM memory, EPROM memory, EEPROM memory, register, hard disk, removable disk, or any other form of storage media known in the art. An exemplary storage medium is coupled to a processor to enable the processor to read and write information from/to the storage medium. In the alternative, the storage medium may be integrated into the processor. The processor and storage medium may reside in an ASIC. The ASIC may reside in the UE. In the alternative, the processor and the storage medium may reside in the UE as discrete components.

In one or more exemplary designs, the described functions can be implemented in hardware, software, firmware, or any combination thereof. If implemented in software, each function can be stored on or transferred by a computer-readable medium as one or more instructions or codes. Computer-readable media include both computer storage media and communication media, which includes any media that facilitates the transfer of computer programs from one place to another. The storage medium may be any available medium that can be accessed by a general-purpose or special-purpose computer.

What has been described above is only an exemplary embodiment of the present disclosure, and is not used to limit the protection scope of the present disclosure, which is determined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an apparatus in a communication system, the method comprising:
obtaining a first sequence for encrypting a complex-valued modulation symbol sequence based on a second sequence, wherein the second sequence is associated with a root key sequence or a secondary key sequence, or with a radio frequency characteristic of a user equipment (UE);
encrypting the complex-valued modulation symbol sequence based on the first sequence to obtain an encrypted complex-valued modulation symbol sequence; and
obtaining a baseband signal based on the encrypted complex-valued modulation symbol sequence.

2. The method of claim 1, wherein obtaining the first sequence for encrypting the complex-valued modulation symbol sequence comprises, based on the second sequence, at least one of:
in case that the second sequence includes at least one real value, obtaining the first sequence including at least one real value or including at least one complex value, real values of the second sequence being in one-to-one correspondence with the real values of the first sequence or the real values of the second sequence being combined into two-by-two, and every two real values of the second sequence respectively corresponding to a real part and an imaginary part of one complex value of the first sequence; and
in case that the second sequence includes at least one binary value, de-quantizing or modulation mapping the binary value to obtain a third sequence including at least one real value or including at least one complex value, and based on the third sequence, obtaining the first sequence including at least one real value or including at least one complex value, the real values of the third sequence being in one-to-one correspondence with the real values of the first sequence or the real values of the third sequence being combined into two-by-two, and every two real values of the third sequence respectively corresponding to a real part and an imaginary part of one complex value of the first sequence, or complex values of the third sequence being in one-to-one correspondence with the complex values of the first sequence.

3. The method of claim 1, further comprising:
obtaining first information associated with one or more radio frequency characteristics of the UE; and
obtaining the second sequence based on the first information and a first correspondence,
wherein the first correspondence includes a correspondence of a plurality of first ranges of the first information and a plurality of second sequences.

4. The method of claim 3, further comprising:
receiving first configuration information from a network node; and
determining, based on the first configuration information, the one or more radio frequency characteristics from a first set including a plurality of radio frequency characteristics of the UE,
wherein the first configuration information includes at least one of:
information associated with the one or more radio frequency characteristics;
the first set; or
the first correspondence.

5. The method of claim 4, wherein:
the first configuration information is configured via first control information; or
the first set is configured via a higher layer signaling and the first configuration information is configured via second control information.

6. The method of claim 1, wherein encrypting the complex-valued modulation symbol sequence based on the first sequence to obtain the encrypted complex-valued modulation symbol sequence comprises:
based on a correspondence of the first sequence to the complex-valued modulation symbol sequence, encrypting at least one of a phase or an amplitude of the complex-valued modulation symbol sequence using the first sequence to obtain the encrypted complex-valued modulation symbol sequence.

7. The method of claim 6, further comprising:
transmitting second information to a network node, wherein the second information includes at least one of information associated with an encrypted communication channel state, information associated with an encryption scheme or encryption weight desired by the UE; and
obtaining at least one of the encryption scheme or the encryption weight based on third information received from the network node including association with at least one of the encryption scheme or the encryption weight configured by the network node,
wherein the encryption scheme includes at least one of a phase-based encryption scheme, an amplitude-based encryption scheme, or a phase and amplitude-based encryption scheme.

8. The method of claim 1, wherein encrypting a phase of the complex-valued modulation symbol sequence using the first sequence to obtain the encrypted complex-valued modulation symbol sequence comprises:
performing, based on a phase transformation value, phase transformation on respective symbols of the complex-valued modulation symbol sequence to obtain the encrypted complex-valued modulation symbol sequence, and
wherein the phase transformation value is associated with at least one of: a real value, a real part of a complex value, an imaginary part of a complex value, or a phase of a complex value of a respective symbol in the first sequence.

9. The method of claim 1, wherein encrypting an amplitude of the complex-valued modulation symbol sequence using the first sequence to obtain the encrypted complex-valued modulation symbol sequence comprises:
performing amplitude transformation on respective symbols of the complex-valued modulation symbol sequence based on an amplitude change value to obtain the encrypted complex-valued modulation symbol sequence, and
wherein a magnitude change value is associated with at least one of: a real value, a real part of a complex value, an imaginary part of a complex value, or a phase of a complex value of a respective symbol in the first sequence.

10. The method of claim 1, wherein encrypting at least one of a phase or an amplitude of the complex-valued modulation symbol sequence using the first sequence to obtain the encrypted complex-valued modulation symbol sequence comprises:
performing at least one of a sum or a weighted sum on the complex-valued modulation symbol sequence and the first sequence including at least one complex value to obtain the encrypted complex-valued modulation symbol sequence.

11. The method of claim 10, wherein encrypting at least one of the phase or the amplitude of the complex-valued modulation symbol sequence using the first sequence to obtain the encrypted complex-valued modulation symbol sequence comprises:
encrypting the complex-valued modulation symbol sequence based on at least one of the obtained encryption scheme or encryption weight using the first sequence to obtain the encrypted complex-valued modulation symbol sequence.

12. The method of claim 1, further comprising:
reading symbols of a stored first sequence from a circular buffer according to at least one of a starting position of a read circular buffer or an order of the read circular buffer, and sequentially encrypting respective symbols in the complex-valued modulation symbol sequence using the read symbols of the first sequence.

13. An apparatus comprising:
a transceiver; and
a processor coupled with the transceiver and configured to:
obtain a first sequence for encrypting a complex-valued modulation symbol sequence based on a second sequence, wherein the second sequence is associated with a root key sequence or a secondary key sequence, or with a radio frequency characteristic of a user equipment (UE);
encrypt the complex-valued modulation symbol sequence based on the first sequence to obtain an encrypted complex-valued modulation symbol sequence; and
obtain a baseband signal based on the encrypted complex-valued modulation symbol sequence.

14. The apparatus of claim 13, wherein the processor is further configured to, at least one of:
in case that the second sequence includes at least one real value, obtain the first sequence including at least one real value or including at least one complex value, real values of the second sequence being in one-to-one correspondence with the real values of the first sequence; or, the real values of the second sequence being combined into two-by-two, and every two real values of the second sequence respectively corresponding to a real part and an imaginary part of one complex value of the first sequence; or
in case that the second sequence includes at least one binary value, de-quantize or modulation map the binary value to obtain a third sequence including at least one real value or including at least one complex value, and based on the third sequence, obtain the first sequence including at least one real value or including at least one complex value, the real values of the third sequence being in one-to-one correspondence with the real values of the first sequence or the real values of the third sequence being combined into two-by-two, and every two real values of the third sequence respectively corresponding to a real part and an imaginary part of one complex value of the first sequence; or complex values of the third sequence being in one-to-one correspondence with the complex values of the first sequence.

15. The apparatus of claim 13, wherein, to obtain the second sequence, the processor is further configured to:
obtain first information associated with one or more radio frequency characteristics of the UE; and
obtain the second sequence based on the first information and a first correspondence, and
wherein the first correspondence includes a correspondence of a plurality of first ranges of the first information and a plurality of second sequences.

16. The apparatus of claim 15, wherein the processor is further configured to:
receive first configuration information from a network node; and
determine, based on the first configuration information, the one or more radio frequency characteristics from a first set including a plurality of radio frequency characteristics of the UE,
wherein the first configuration information includes at least one of:
information associated with the one or more radio frequency characteristics;
the first set; or
the first correspondence.

17. The apparatus of claim 16, wherein:
the first configuration information is configured via first control information; or
the first set is configured via a higher layer signaling and the first configuration information is configured via second control information.

18. The apparatus of claim 13, wherein the processor is further configured to:
based on a correspondence of the first sequence to the complex-valued modulation symbol sequence, encrypt at least one of a phase or an amplitude of the complex-valued modulation symbol sequence using the first sequence to obtain the encrypted complex-valued modulation symbol sequence.

19. The apparatus of claim 13, wherein the processor is further configured to:
perform, based on a phase transformation value, phase transformation on respective symbols of the complex-valued modulation symbol sequence to obtain the encrypted complex-valued modulation symbol sequence, and
wherein the phase transformation value is associated with at least one of: a real value, a real part of a complex value, an imaginary part of a complex value, or a phase of a complex value of a respective symbol in the first sequence.

20. The apparatus of claim 13, wherein the processor is further configured to:
perform amplitude transformation on respective symbols of the complex-valued modulation symbol sequence based on an amplitude change value to obtain the encrypted complex-valued modulation symbol sequence, and
wherein a magnitude change value is associated with at least one of: a real value, a real part of a complex value, an imaginary part of a complex value, or a phase of a complex value of a respective symbol in the first sequence.
